(19) United States
(12) Patent Application Publication
(10) Pub. No.: US 2006/0061326 A1
(43) Pub. Date: Mar. 23, 2006

(54) Adaptor to facilitate contactless charging in an electronic device

(76) Inventors: Douglas A. Vine, Suwanee, GA (US); Seng Chan, Suwanee, GA (US); David M. DeMuro, Lawrenceville, GA (US)

Correspondence Address: MOTOROLA INC, 600 NORTH US HIGHWAY 45, ROOM AS437, LIBERTYVILLE, IL, 60048-5343, US

(21) Appl. No.: 10/948,471

(22) Filed: Sep. 23, 2004

(51) Int. Cl. H02J 7/00

(52) U.S. Cl. 320/108

(57) ABSTRACT

An adaptor for converting a conventional electronic device into one capable of being charged by a contactless charger is provided. The adaptor has a base member that couples to the electronic device, and a sliding member that includes a contact block for electrically coupling the adaptor to the electronic device. The base member includes a contactless pick-up coil for receiving energy from a conatactless charger. The base member is coupled to the electronic device, and the sliding member is moved from an extended position to a retracted position, thereby coupling the electrical contacts of the contact block to a charging receptacle on the electronic device.

### BACKGROUND

1. Technical Field

This invention relates generally to contactless charging devices, and more specifically to an adaptor for enabling a portable electronic device to be charged by a contactless charger.

2. Background Art

Contactless, or inductive, electrical connections are well known in the field of portable electrical devices. For example, portable, motorized toothbrushes typically contain a rechargeable battery which is charged by an inductive connection. Similarly, portable wireless communication devices, such as two-way RF radios, cellular phones, paging devices, and wireless communicators, commonly utilize a rechargeable battery that, in certain applications, is recharged by contactless, induction charging.

Most all contactless chargers charge batteries by induction. Current, passed through a coil, creates a magnetic flux in accordance with Ampere's law. When a second coil is placed in close proximity to such a current-driven coil, the flux couples to the second coil, thereby “inducing” a current in the second coil. Such an induction circuit is illustrated in FIG. 1.

Turning now to FIG. 1, an inductively coupled charging system 10 has a primary side or base device 12 and a secondary side or portable device 16. A primary controller used as a primary charging device 11 as would be well known to one of ordinary skill in the art, is shown connected to the AC power source and to a primary coil 13. The primary coil 13 is shown inductively coupled to secondary coil 15 by field 14. The secondary coil 15, also known as a “pick-up coil”, is coupled to battery 21 through a secondary charging device which is shown in this example as a rectifier circuit 19. The battery 21 in turn is connected to the load shown as RL 23. As would be well known to one of ordinary skill in the art, the energy coupled from the primary coil 13 is applied through the secondary coil 15 to charge the battery 21. The primary coil 13 is often placed in a charger that resembles a flat pad. One charges the battery by placing an electronic device upon the pad such that the pick-up coil 15 in the electronic device is in close proximity with the primary coil 13.

Given the convenience of contactless chargers, as a user can charge a device by simply placing it upon a pad rather than inserting it into a specifically designed pocket, consumers have begun to demand contactless charging systems for their electronic devices. The problem that they face is that many of today's electronic devices were not designed to be charged by a contactless charger. Consequently, these electronic devices lack the required contactless charging elements like the pick-up coil and associated circuitry. New electronic devices, like cellular phones, can cost as much as five hundred dollars or more. As such, it is often cost prohibitive for a consumer who has a conventional electronic device, to take advantage of the convenience of contactless charging.

Accordingly, there is a need for an improved, contactless charging system that facilitates contactless charging of conventional electronic devices.

### BRIEF DESCRIPTION OF THE DRAWINGS

FIG. 1 illustrates a prior art contactless, inductive charging circuit.

FIG. 2 illustrates an exploded view of an adaptor in accordance with the invention.

FIG. 3 illustrates a partially assembled adaptor in accordance with the invention.

FIG. 4 illustrates a perspective view of an adaptor in accordance with the invention.

FIG. 5 illustrates the sliding or coupling member of an adaptor in accordance with the invention engaging with a charging receptacle on an electronic device.

FIGS. 6 and 7 illustrate perspective views of an adaptor in accordance with the invention coupled to an electronic device.

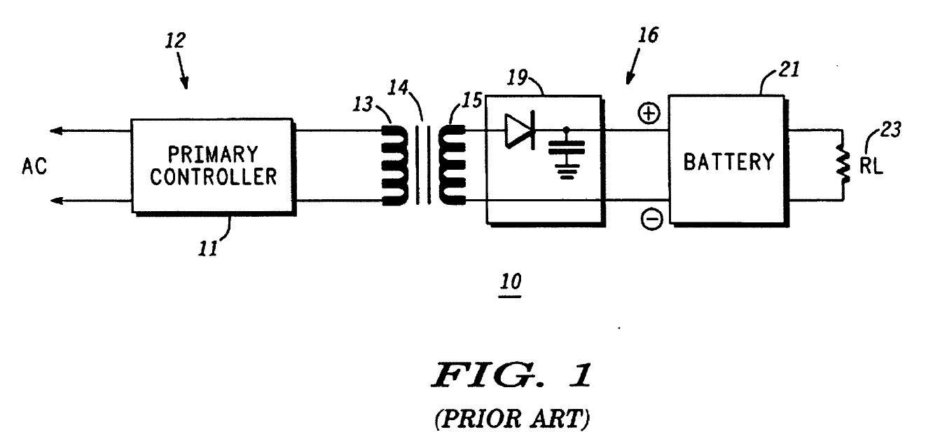

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”This invention is an adaptor that includes a contactless charging pick-up coil and an electrical contact block capable of coupling to a receptacle on an electronic device. The pick-up coil is located in a base member that attaches to the electronic device. The contact block is located on a sliding member that slides into and out from the base member. When the base member is attached to the electronic device, the sliding member then slides into the base member, thereby engaging the contact block of the adaptor to the charging receptacle on the electronic device. In so doing, the adaptor couples a contactless pick-up coil and associated circuitry to the electronic device, thereby converting the electronic device into one capable of being charged by contactless chargers.

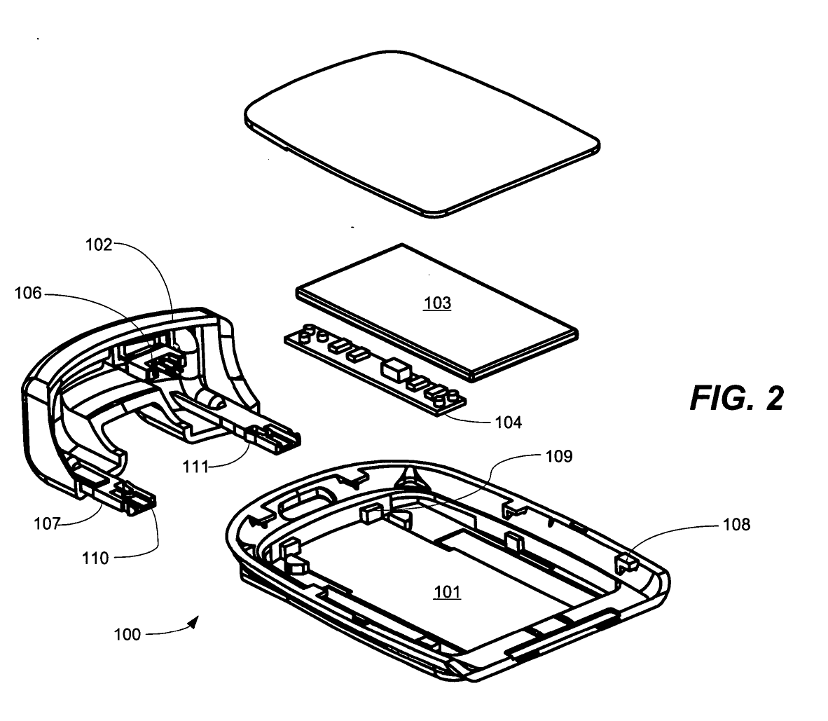

Turning now to FIG. 2, illustrated therein is an exploded, perspective view of one preferred embodiment of an adaptor 100 in accordance with the invention. The adaptor 100 includes a base member 101 and a coupling member or sliding member 102. The base member 101 includes the contactless charging pick-up coil 103, and may included corresponding circuitry 104. The sliding member 102 includes an electrical connector 106, or “contact block”, for coupling to a charging receptacle on the electronic device.

The base member 101 is capable of mechanically attaching to the electronic device. Many devices today, including most popular cellular telephones, have a rechargeable battery that is covered by a battery door. For devices like these, the base member 101 may be designed to substitute for the battery door. In other devices, the base member 101 may be equipped with hooks 108 or latches to facilitate coupling to the electronic device.

Once the base member 101 has been attached to the electronic device, the sliding member 102 moves from an extended position to a retracted position, thereby engaging the contact block 106 with the charging receptacle on the electronic device. This engagement couples the pick-up coil 103 to either the rechargeable battery of the electronic device or to charging circuitry disposed within the electronic device to facilitate contactless charging. Note that the optional circuitry 104 in the base member may comprise charging circuitry for a rechargeable battery such that the adaptor 100 may charge a rechargeable battery directly. In other embodiments, the circuitry 104 may include conditioning circuitry, safety circuitry, circuits measuring the efficiency of charge and fuel gauging circuitry.

The base member 101 and sliding member 102 may be manufactured from a variety of materials, including plastics and metal. One preferred method of manufacture is by way of injection molding with a high-strength plastic like polycarbonate-ABS. Injection molding allows great flexibility in designing the base member 101 and sliding member 102 form factors so as to be complimentary, and thus readily attachable, to the electronic device.

The sliding member 102 may be coupled to the base member 101 in a number of ways. In this preferred embodiment, the sliding member 102 includes extensions 107 that are inserted into apertures 109 in the base member 101. The extensions 107 may include slots 110 or snaps 111 that ensure that the sliding member 102 does not overextend out of the base member 101. It will be clear to those of ordinary skill in the art having the benefit of this disclosure that other base member 101 to sliding member 102 connection schemes may equally be employed.

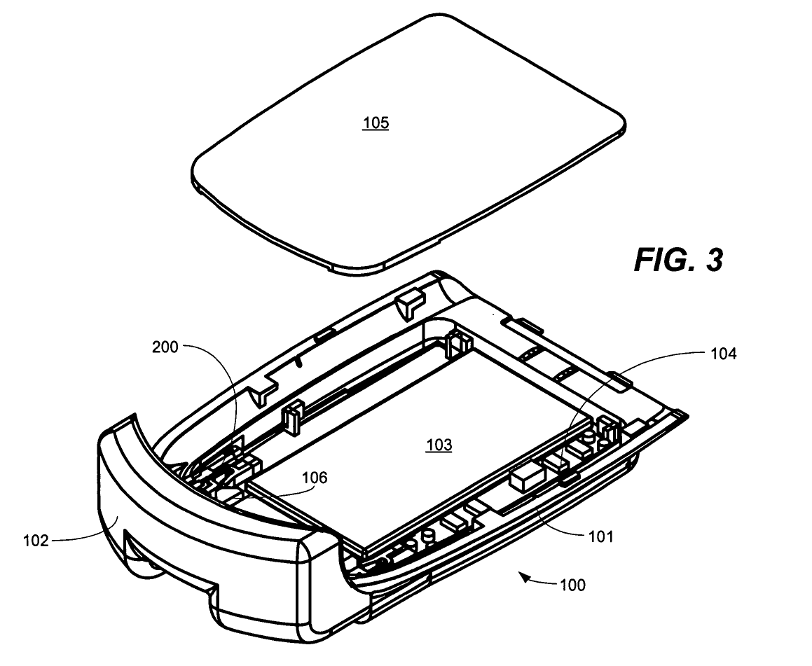

Turning now to FIG. 3, illustrated therein is a perspective view of the adaptor 100 after some of the components have been assembled. In FIG. 3, the sliding member 102 has been inserted into the base member. The pick-up coil 103 has been placed in the base member 101, along with the corresponding circuitry 104. Electrical conductors (not shown) couple the pick-up coil 103, the circuitry 104 and the contact block 106. The contact block includes electrical contacts 200 that couple the energy received from the pick-up coil 103 to the electronic device. Once the pieces are assembled, a cover plate 105 is placed atop the pick-up coil 103 so as to seal both the pick-up coil 103 and circuitry safety 104 within the adaptor 100.

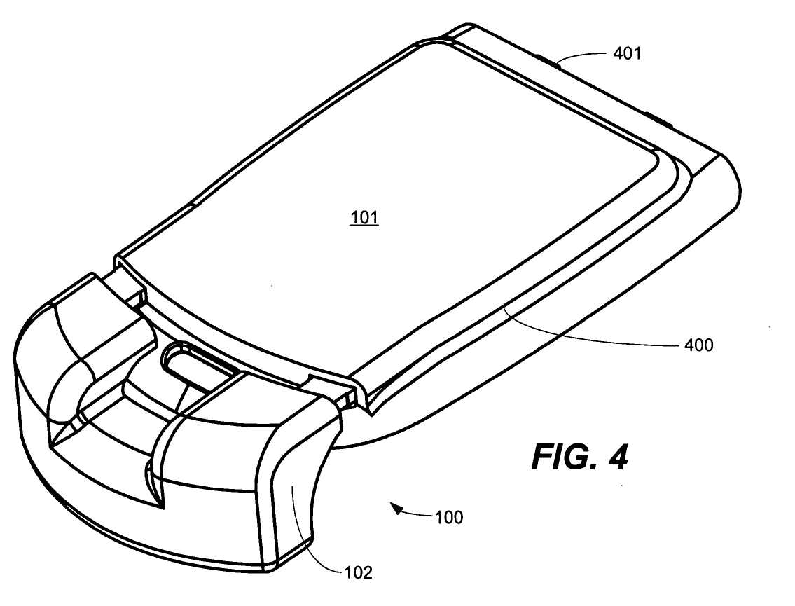

Turning now to FIG. 4, illustrated therein is a rear view of the assembled adaptor 100. As can be seen, the sliding member 102 is capable of mechanically sliding from a first, extended position to a second, retracted position. Additionally, for those applications where the base member 101 is going to serve as a substitute for the battery door of the electronic device, the base member 101 may include curves and contours 400 so as to be aesthetically compatible with the curves and contours of electronic device to which it is being attached. The base member 101 may also include protrusions or other mechanical connectors 401 for attaching to the electronic device.

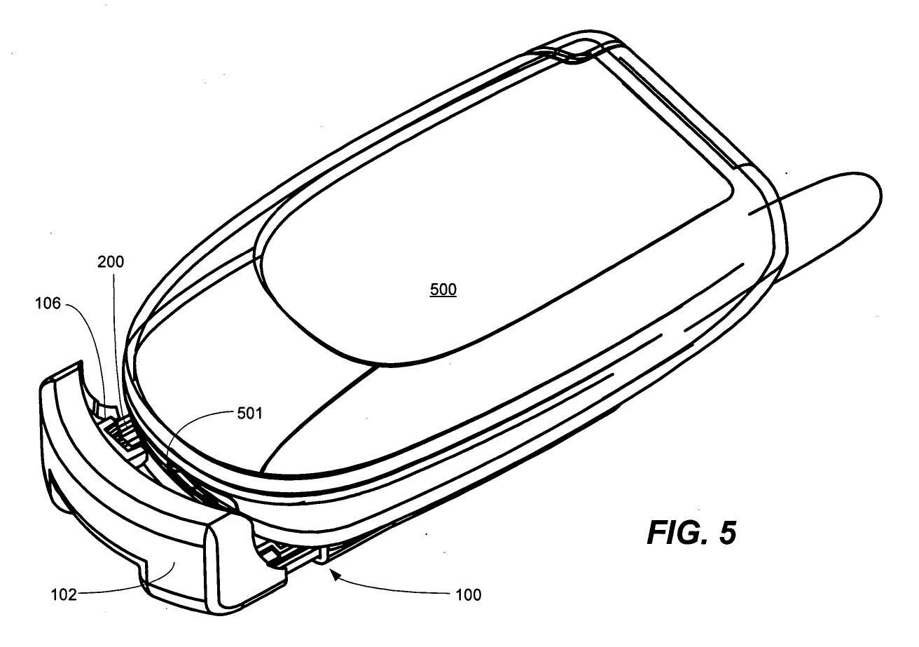

Turning now to FIG. 5, illustrated therein is an adaptor 100 in accordance with the invention being coupled to an electronic device 500. The electronic device 500 includes a receptacle 501 for coupling to a charger. In FIG. 5, the sliding member is in the process of moving from the extended position to the retracted position so as to couple the contact block 106, and its electrical contacts 200, with the charging contacts disposed within the receptacle 501 of the electronic device 500.

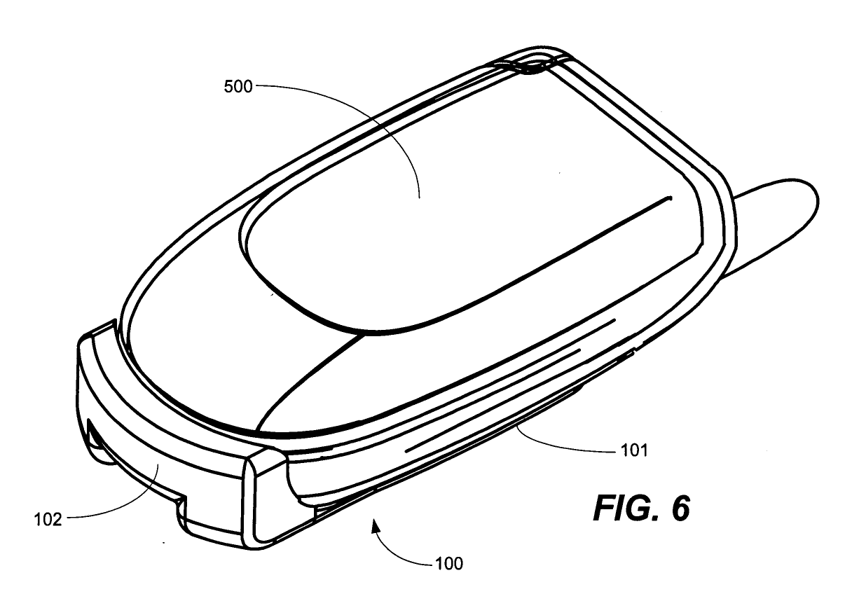

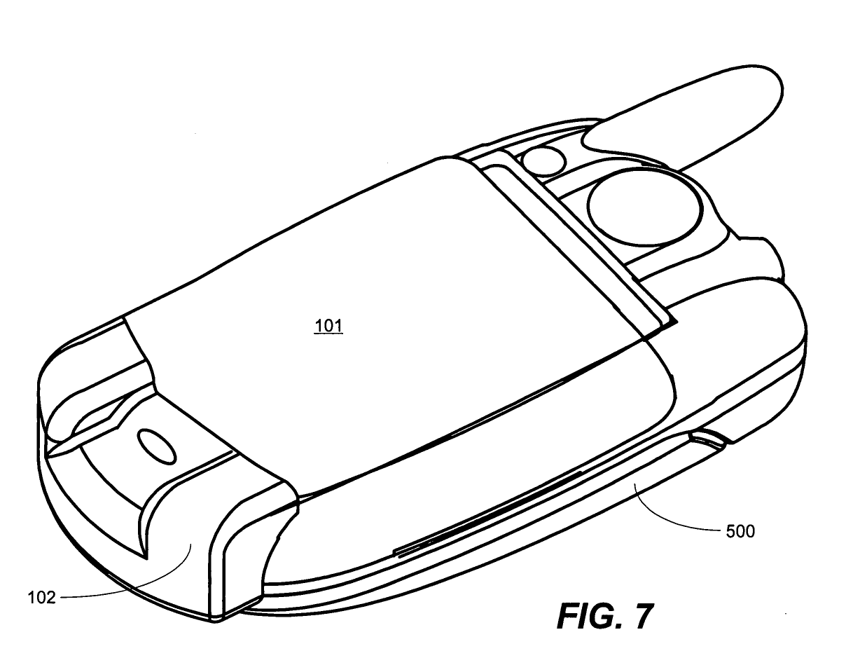

Turning now to FIGS. 6 and 7, illustrated therein are perspective views of the adaptor 100 when coupled to the electronic device 500. The base member 101 has been mechanically attached to the device 500, and the sliding member 102 has been moved to the retracted position such that the pick-up coil disposed in the adaptor 100 is now electrically coupled to the electronic device 500 so as to facilitate charging of the rechargeable battery disposed within the device 500. The electronic device 500, which formerly could only be charged by connecting a wire or charger, may now be charged simply by placing the adaptor/device assembly on a contactless charger such that the pick-up coil may receive power from the primary coil of the contactless charger.

The invention may be used with a variety of devices, including cellular telephones, pagers, personal digital assistants, MP3 players, portable computers, two-way radios and electronic games. The invention allows a user to take advantage of the convenience of contactless charging without having to invest in a completely new electronic device. Additionally, the invention, being detachable, allows a user to charge the electronic device from a plurality of sources. For example, if the user desires contactless charging, the user may employ the adaptor. However, if the user is traveling and would rather use a vehicular adaptor, the user may simply remove the adaptor and connect a conventional, wired power source.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. An adaptor to facilitate contactless charging in an electronic device, the adaptor comprising:
a. a base member comprising a contactless charging pick-up coil; and
b. a coupling member comprising an electrical connector for coupling to the electronic device;
wherein the coupling member is capable of mechanically sliding from a first, extended position to a second, retracted position.

2. The adaptor of claim 1, further comprising electronic circuitry coupled to the contactless charging pick-up coil and the electrical connector.

3. The adaptor of claim 2, wherein the electronic circuitry comprises charging circuitry for charging a rechargeable battery.

4. The adaptor of claim 1, wherein the base member comprises a mechanical connector for attaching to the electronic device.

5. The adaptor of claim 1 or 2, wherein when the adaptor is coupled to the electronic device, the contactless charging pick-up coil is electrically coupled to a rechargeable battery of the electronic device.

6. The adaptor of claim 1 or 2, wherein when the adaptor is coupled to the electronic device, the contactless charging pick-up coil is coupled to charging circuitry disposed within the electronic device.

7. The adaptor of claim 4, wherein the electronic device is selected from the group consisting of telephones, pagers, personal digital assistants, MP3 players, portable computers, two-way radios and electronic games.

8. The adaptor of claim 1, wherein the base member comprises a battery door.

9. A contactless charging adaptor for an electronic device, comprising:
a. a base member capable of mechanically coupling to the electronic device, wherein the base member comprises a pick-up coil; and
b. a sliding member comprising a contact block capable of mating with an electrical receptacle of the electronic device.

10. The adaptor of claim 9, wherein the sliding member is capable of mechanically moving from a first, extended position to a second, retracted position.

11. The adaptor of claim 10, further comprising electronic circuitry coupled to the contactless charging pick-up coil and the electrical connector.

12. The adaptor of claim 11, wherein the electronic circuitry comprises charging circuitry for charging a rechargeable battery.

13. The adaptor of claim 9, wherein the base member comprises a mechanical connector for attaching to the electronic device.

14. The adaptor of claim 13, wherein when the adaptor is coupled to the electronic device, the contactless charging pick-up coil is electrically coupled to a rechargeable battery of the electronic device.

15. The adaptor of claim 13, wherein when the adaptor is coupled to the electronic device, the contactless charging pick-up coil is coupled to charging circuitry disposed within the electronic device.

16. The adaptor of claim 13, wherein the electronic device is selected from the group consisting of telephones, pagers, personal digital assistants, MP3 players, portable computers, two-way radios and electronic games.

17. The adaptor of claim 9, wherein the base member comprises a battery door.
